(19) United States
(12) Patent Application Publication
(10) Pub. No.: US 2010/0265816 A1
(43) Pub. Date: Oct. 21, 2010

(54) MONITORING SWITCHING NETWORKS

(75) Inventor: Lynn Johnson, Verona, WI (US)

Correspondence Address: Occhiuti Rohlicek & Tsao LLP, 10 Fawcett Street, Cambridge, MA, 02138, US

(73) Assignee: American Superconductor Corporation, Devens, MA (US)

(21) Appl. No.: 12/425,736

(22) Filed: Apr. 17, 2009

(51) Int. Cl. H04L 12/26

(52) U.S. Cl. 370/217; 370/244

(57) ABSTRACT

A system and method are described for detecting failures of switches in a switching network including a plurality of switches. The sensing circuit includes a plurality of detecting networks, the plurality of detecting networks being fewer than the plurality of switches, each detecting network providing signals indicative of a failure of at least one of the switches.

### BACKGROUND

This application relates to monitoring switching networks as used, for example, in high power regulation devices.

Static VAR correctors, also referred to as static VAR compensators (SVCs), are electrical devices that provide reactance compensation to power transmission networks. SVCs are commonly used in various applications, including, for example, regulating utility line voltage, improving network steady-state stability, and establishing near unity power factor on transmission lines.

Typically, an SVC includes a bank of controllable capacitors and reactors that can be individually switched into and out of a utility power network (e.g., a transmission or a distribution line) by a set of semiconductor switches (e.g., thyristors). Each switch is driven by electrical gating signals generated based on line conditions, allowing the corresponding capacitors or inductors to discharge or conduct in a controlled manner. When using thyristors that are capable of responding to gating signals within a sub-cycle (e.g., on the order of several milliseconds), an SVC is able to provide near-instantaneous reactance flow to compensate voltage or current fluctuations on utility networks. After extended use, thyristors can fail, rendering the SVC inoperable and leading to power service interruptions and costly replacements. For this reason, thyristors are monitored to prevent failure of the SVC.

### SUMMARY

In a general aspect of the invention, a sensing circuit is configured for use with a switching network including a plurality of switches. The sensing circuit includes a plurality of detecting networks, the plurality of detecting networks being fewer in number than the plurality of switches, and each detecting network providing signals indicative of a failure of at least one of the switches.

Implementations of the sensing circuit may include one or more of the following features.

The detecting networks are configured to send a warning signal if the failed switches are greater in number than zero and fewer than or equal to a number of redundant switches in the switching network.

The detecting networks are configured to send a trip signal to disable the switching network if the failed switches are greater in number than the number of redundant switches.

In a general aspect of the invention, a sensing circuit is configured for use with a switching network that includes a plurality of switches and has a number of redundant switches. The sensing circuit includes a plurality of detecting networks configured to send a warning signal indicating that a number of failed switches is greater than zero and is also fewer than or equal to the number of redundant switches. At least one of the detecting networks in the sensing circuit is configured to disable the switching network if a number of failed switches is greater than the number of redundant switches.

Implementations of the sensing circuit may include one or more of the following features.

The plurality of detecting networks is fewer than the number of switches.

In a general aspect of the invention, a sensing circuit is configured for use with a switching network that includes a plurality of switches and has a number of redundant switches. The sensing circuit includes a plurality of detecting networks that are fewer than the plurality of switches. The detecting networks are configured to send a warning signal indicative of a number of failed switches greater than zero and fewer than or equal to the number of redundant switches. At least one of the detecting networks disables the switching network if a number of failed switches is greater than the number of redundant switches.

Implementations of the sensing circuit may include one or more of the following features.

Each of the plurality of detecting networks monitors, at most, a number of switches equaling all the switches in the switching network divided by the number of detecting networks.

A number of detecting networks equals at least two more than the number of redundant switches.

The switches of the switching network are in series.

The number of redundant switches is two or more.

The switches include one or more high-power semiconductor switch-diode pairs or one or more high-power semiconductor switch-switch pairs.

The detecting networks detect voltage.

The detecting networks include dropping networks, which may also include one or more of a resistor divider, a transformer, a set of reactors, or a set of capacitors.

The plurality of detecting networks includes a differential amplifier.

The plurality of detecting networks includes a processor that compares voltages across one or more of the plurality of switches.

In a general aspect of the invention, a method of monitoring a switching network containing a plurality of switches, includes: obtaining signals from each of a plurality of detecting networks, wherein at least one detecting network monitors two or more switches; determining a number of failed switches in the switching network based on the received signal; and performing one or more actions depending on the number of failed switches in the switching network.

Implementations of the method may include one or more of the following features.

Obtaining signals includes measuring voltages across one or more switches using a dropping network or a differential amplifier.

Determining includes comparing the received signals to stored signals representative of a known number of failed switches.

Performing one or more action depending on the number of failed switches in the switching network includes sending a warning signal indicative of the number of failed switches if the number of failed switches is greater than zero and fewer than or equal to a number of redundant switches in the switching network. Performing one or more action depending on the number of failed switches in the switching network also includes disabling the switching network if the number of failed switches is greater than the number of redundant switches in the switching network.

The above-described systems and methods may include one or more of the following advantages.

Switches in a switching network can be monitored efficiently and effectively. A switching network having a redundant number of switches can be monitored so that the network continues normal operation even after a number of switches up to and including the redundant number of switches have failed. In this scenario, a warning is sent to alert that switches have failed so that maintenance can be scheduled.

In the event that more than the redundant number of switches fails, the monitoring system and methods disable the switching network, preventing damage to the network.

The switch monitoring systems and methods are efficient and cost-effective because the status of each switch is inferred without having to employ a separate monitor for each switch.

Other features and advantages of the invention are apparent from the following description, and from the claims.

### DESCRIPTIONS OF DRAWINGS

FIG. 1 shows a static volt-ampere reactive compensator system connected to a portion of a utility power system.

FIG. 2 is an example switch controlling and monitoring system.

FIG. 3 is a flowchart listing an example measurement process to obtain data used in monitoring switches.

FIGS. 4A and 4B are tables listing measurement data used in monitoring switches.

FIG. 5 is a flowchart listing an example process to monitor and control a device containing a plurality of switches.

FIG. 6 shows an alternative implementation of a switch controlling and monitoring system.

### DETAILED DESCRIPTION

### System Overview

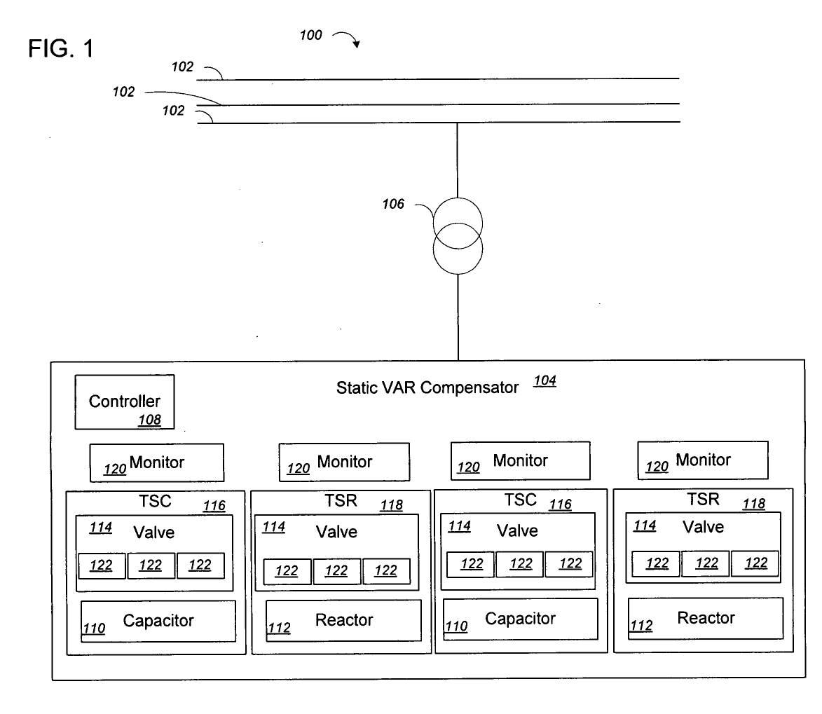

Referring to FIG. 1, a portion of a utility power system 100 includes a static volt-ampere reactive (VAR) compensator (SVC) 104, which is stationed at various points along transmission or distribution lines 102 to regulate transmission or distribution line voltage, improve network stability, control reactive power flow, and reduce energy losses. For convenience, SVC 104 is shown as connected to only one phase of the transmission line 102. SVCs include switches, here thyristors 122, which are integral to the proper functioning of SVCs. Thus, SVCs are often provided with redundant numbers of thyristors to ensure continuous SVC operation. When redundant thyristors are installed, that is, the SVC contains more than the minimum number of thyristors required for normal SVC operation, the SVC can still function properly even after a number of the thyristors fail (as long as the number of failed thyristors is fewer than or equal to the number of redundant thyristors).

Generally, each of the monitors 120 receives signals related to associated groups of thyristors 122 and report to a controller 108 how many of the thyristors have failed. When the number of failed thyristors is fewer than or equal to the number of redundant thyristors, the controller 108 sends a warning. For example, the warning can be received by an operator who then schedules a replacement of the failed thyristors.

When the monitor 120 reports that the number of failed thyristors is greater than the number of redundant thyristors, the controller 108 disables the SVC 104. As will be described in greater detail below, an arrangement of monitors 120 and a method of operation of the monitors permit an efficient, effective means for monitoring the thyristors 122 within an SVC 104.

The SVC 104 regulates voltage by controlling the amount of reactive power injected into or absorbed from the power network. For example, when the network voltage is low, as can happen when customer usage increases during summer months, the SVC generates capacitive reactive power. On the other hand, when the system voltage is high, the SVC absorbs inductive reactive power. A controller 108 measures a stepped-down voltage and includes or excludes multi-phase banks of capacitors 110 and banks of inductors 112 in the utility power system 100 as needed. Valves 114 include a series of thyristors and control the capacitor banks 110, which are referred to as thyristor-switched capacitors (TSCs) 116, and inductor banks, which are referred to as thyristor-switched reactors (TSRs) 118. Alternatively or in addition, inductors can be controlled by different phases, in which case they are referred to as thyristor-controlled reactors (TCRs, which are not shown in FIG. 1). A monitor 120 is associated with one or more TSC 116 or TSR 118 and measures parameters related to the functionality of multiple thyristors 122 within the valves 114.

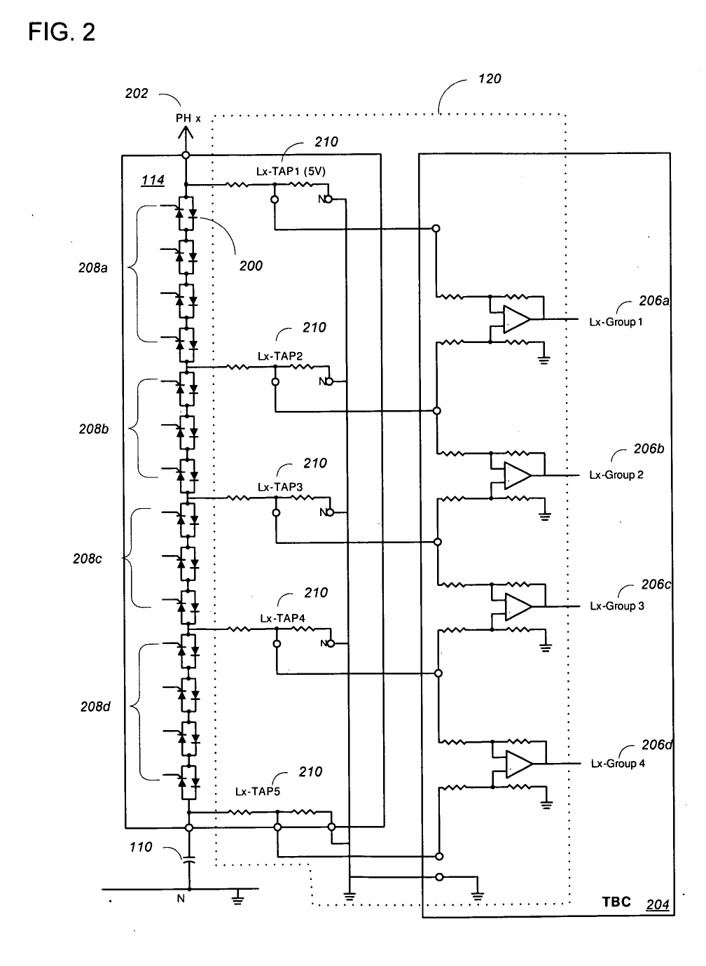

Referring to FIG. 2, an example valve 114 includes or excludes the capacitor 110 as part of the circuit. The valve 114 includes a number of thyristor-diode pairs 200 that function as switches. The thyristor 122 is included in the thyristor-diode pair 200. The valve 114 also includes supporting hardware, such as heat sinks, gates, cooling equipment, and gating circuits (none of which are shown in FIG. 2). The number of thyristor-diode pairs 200 required for usage of the valve 114 depends on the voltage across the valve and the rating of the thyristor-diode pairs. For example, a point 202 on one side of the valve is at a line voltage of 23,000 volts and there is a 13,200 volt line to neutral. The capacitor 110 will charge to the peak voltage because of the diodes in the thyristor-diode pairs 200. A common design practice is for the TSR voltage rating of the valve 114 to be two times the peak line to neutral, or about 39,000 volts to withstand the peak voltage, and, for a TSC 116, to increase the rating by a factor of four, or about 78,000 volts, in order to withstand peak-to-peak voltage. If the thyristor in the TSC thyristor-diode pair 200 is rated for 6,500 volts, 12 thyristors would be the minimum number required and two additional thyristors could be included for redundancy. Valve 114 contains two redundant thyristor-diode pairs 200, for a total of 14 thyristor-diode pairs. The level of redundancy can be higher or lower. At higher voltages or different thyristor ratings, the number of thyristor-diode pairs 200 is changed as needed.

Thyristors within the valve 114 can fail, for example, because of over-voltage or over-current operating conditions, inadequate cooling, or mechanical damage. When a thyristor fails, it often shorts as its failure mode, causing the voltages to change across the thyristor-diode pair 200 as well as across the entire series of thyristor-diode pairs in the valve 114. To monitor for failure of the valve 114 and the SVC 104, the monitor 120 (shown within a dotted line) measures parameters (e.g., voltages) related to the functionality of the thyristors within the valves 114.

The monitor 120 is integrated between the valve 114 and a thyristor bank controller 204 either during initial construction or by retrofitting. The monitor 120 contains four detection groups (e.g., detection groups 206a-d) that each monitors a group (e.g., groups 208a-d) of three or four thyristor-diode pairs 200. In the example shown in FIG. 2, detection group 206a monitors four thyristor-diode pairs 200 in group 208a, detection group 206b monitors three thyristor-diode pairs 200 in group 208b, detection group 206c monitors three thyristor-diode pairs 200 in group 208c, and detection group 206d monitors four thyristor-diode pairs 200 in group 208d. Each of the detection groups 206a-d is connected to two taps 210 and measures the voltage difference between the two taps, for example, in hardware, such as a dropping network (e.g., a resistor divider, a transformer, a set of reactors, or a set of capacitors), or in software, by passing the measured voltages to a processor for further analysis. As shown in the implementation of FIG. 2, the taps 210 include a resistor divider network. More generally, a minimum number of the detection groups 206a-d is needed to detect patterns of failure among the groups 208 of thyristor-diode pairs 200. The minimum number of detection groups 206a-d depends on the redundancy of the system and is typically equal to two more than the redundancy of thyristor-diode pairs 200 in the valve 114. In FIG. 2, the four detection groups 206a-d are sufficient to monitor the 14 thyristor-diode pairs 200.

### Method of Use

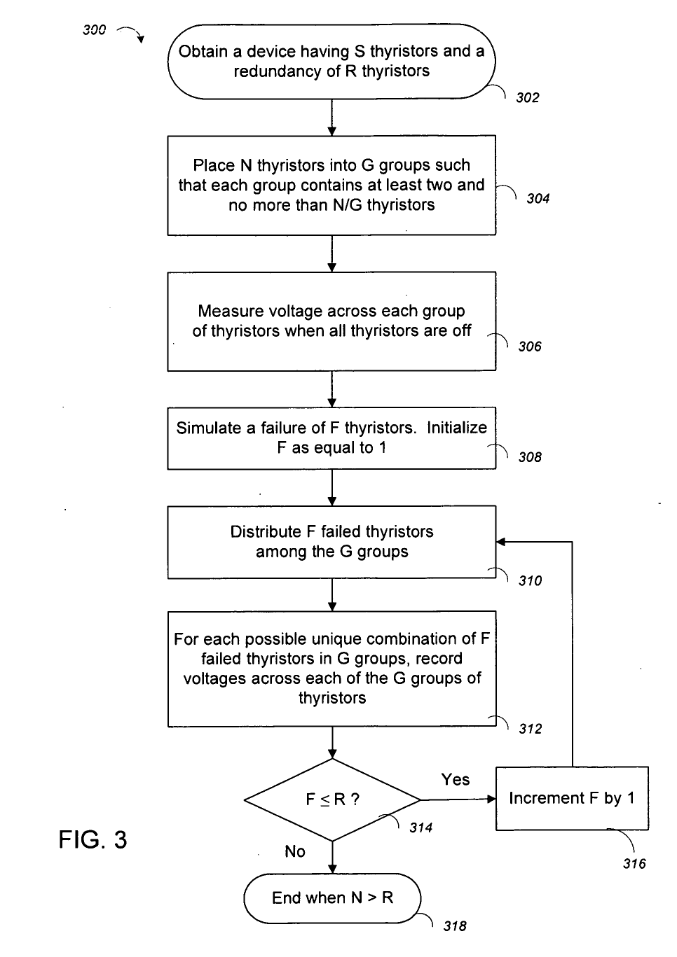

Referring to FIG. 3, a flowchart 300 illustrates a process of using detection groups 206a-d for measuring changes in voltage across groups 208a-d of thyristors 122 after various numbers of thyristors have failed. A device having S number of thyristors and a redundancy equal to R number of thyristors is obtained (302). N number of thyristors is placed (304) into a number G of groups such that each group contains at least two but no more than N/G thyristors. Voltages are measured (306) across each group of thyristors when all thyristors are off. A failure of F number of thyristors is simulated (308), in which F is initialized to equal 1. The F failed thyristors are distributed (310) among the G groups. For each possible unique combination of F failed thyristors in G groups, voltages across each of the G groups of thyristors are recorded (312). While F, the number of simulated failed thyristors, is fewer than or equal to R, the number of redundant thyristors, F is incremented (314) by 1. The additional failed switch is distributed (310) among the G groups and, for each possible unique combination of F failed thyristors in G groups, the voltages across each of the G groups of thyristors is again recorded (312). After F has been incremented to be greater than R, the process ends (316) and the measured voltages can be used by the controller 108 to determine how many thyristors 122 have failed. In some examples, symmetry of the thyristors 122 and the resulting symmetry in the patterns of voltage changes after thyristor failures will reduce the number of voltages that are recorded (312) after a failure of F thyristors in G groups.

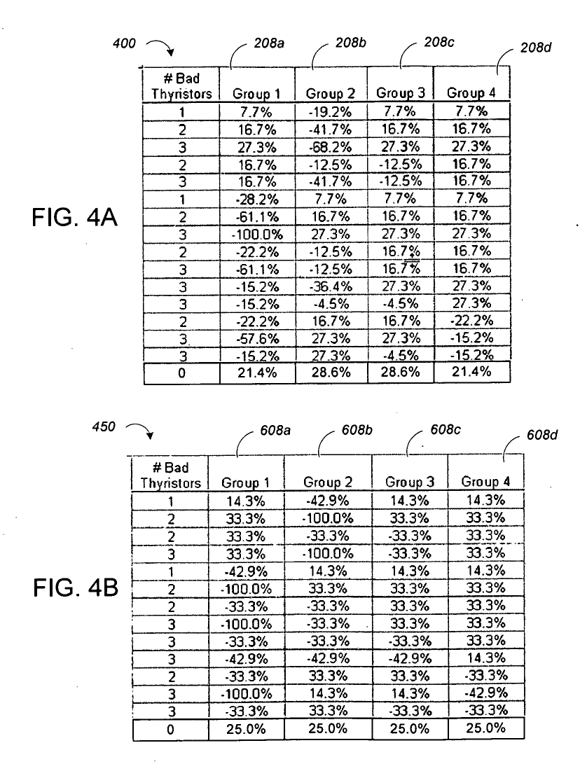

Referring to FIG. 4A, a table 400 lists data obtained by the measurement process described in the flowchart 300 for TSC groups 208a-d of thyristors in the valve 114. Listed at the bottom of the table 400 are the voltages measured across the four groups 208a-d of thyristor-diode pairs 200 when all thyristors are functioning properly. Voltages are expressed as a percentage of the voltage drop between the point 202 (which is typically at a voltage of 25,000 volts) and the capacitor 110. Detection group 206a measures a voltage between two taps 210 on either side of group 208a to be 21.4%, detection group 206b measures a voltage of 28.6% across group 208b, detection group 206c measures a voltage of 28.6% across group 208c, and detection group 206d measures a voltage of 21.4% across group 208d. Symmetries exist between groups 208a and 208d and also between groups 208b and 208c. These symmetries reduce the number of separate measurements required for recording voltages across each of group 208a-d when a number of failed thyristors are distributed among the groups.

Referring to the other rows of table 400, measured voltages across the TSC groups 208a-d are listed, in which one, two, or three shorted thyristors are distributed among the groups. A negative voltage value indicates that the voltage across a group has decreased and the group contains one or more shorted thyristors. For example, the top row of table 400 lists voltages measured when one failed thyristor is distributed among groups 208a-d. A voltage of 7.7% is measured across each of groups 208a, 208c, and 208d, and a voltage of −19.2% is measured across group 208b. As such, the failed switch is localized to group 208b. Because of the noted symmetry in the groups 208b and 208c, if the failed switch were instead in group 208c, the voltage across each of groups 208a, 208b, and 208d would be 7.7% and the voltage across group 208c would be −19.2%.

The sixth row of table 400 lists voltages measured when one failed thyristor is located in group 208a. In this scenario, a voltage of 7.7% is measured across each of groups 208b, 208c, and 208d, and a voltage of −28.2% is measured across group 208a. Because of the noted symmetry in the groups 208a and 208d, if the failed switch were instead in group 208d, the voltage across each of groups 208a, 208b, and 208c would be 7.7% and the voltage across group 208d would be −28.2%. The remaining rows of table 400 list the measured voltages across the groups 208a-d, in which two or three shorted thyristors are distributed among the groups.

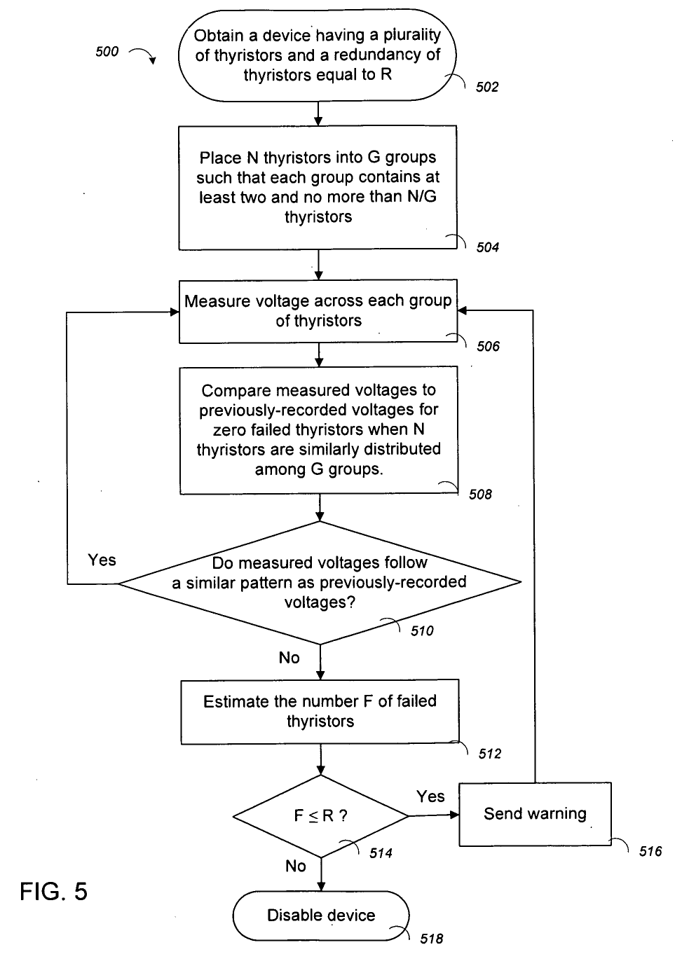

Referring to FIG. 5, a flowchart 500 describes a process to monitor and control a device (e.g., the SVC 104) containing a plurality of thyristors (thyristor-diode pairs 200). A device is obtained (502) having a plurality of thyristors and a redundancy of thyristors equal to R number. N number of thyristors is placed (504) into G number of groups such that each group contains at least two but no more than N/G thyristors. A voltage across each group of thyristors is measured (506). The measured voltages are compared (508) to previously-recorded voltages for zero failed thyristors. A decision is made (510) whether or not the measured voltages across the groups follow a similar pattern as the previously-recorded voltages for zero failed thyristors. If the measured voltages are similar, then a voltage across each group of thyristors is measured (506) again. If the measured voltages are not similar, then a number F of failed thyristors is estimated (512), for example, by matching the measured voltages to a pattern of previously-measured voltages for one, two, or three failed thyristors. A decision is made (514) if the number of failed thyristors F is fewer than or equal to the number of redundant thyristors R. If F is fewer than or equal to R, a warning is sent (516) and a voltage across each group of thyristors is measured (506) again. If F is greater than R, the device is disabled (518).

### Alternative Embodiments

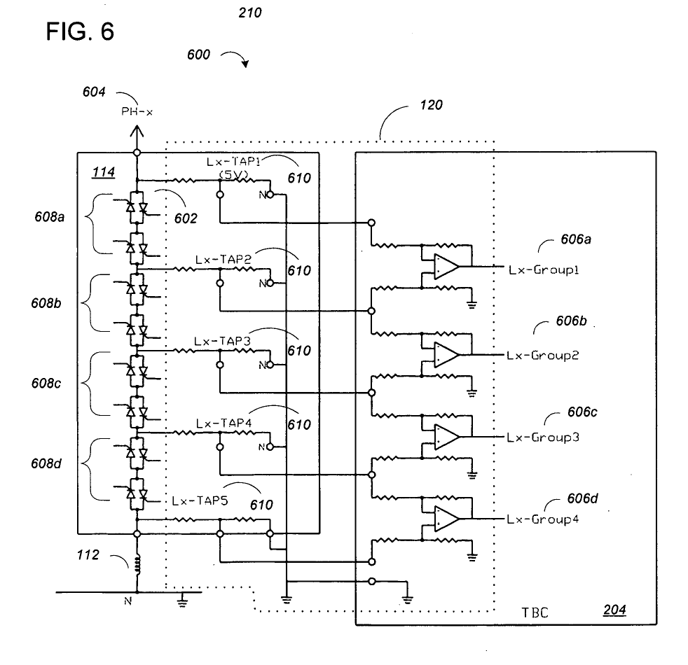

It is to be understood that the configurations of the monitor 120 shown in FIG. 2 is one example implementation. An alternative design is shown in FIG. 6 and includes the monitor 120 interfacing an example valve 114 that includes or excludes the inductor 112 as part of the circuit. The valve 114 includes a number of thyristor-thyristor pairs 602 that function as switches. Thyristors 122 are included in the thyristor-thyristor pair 602. The number of thyristor-thyristor pairs 602 required depends on the voltage across the valve 114 and the rating of the thyristor-thyristor pairs. For example, a point 604 on one side of the valve is at a voltage of 23,000 volts. Because there are thyristors in both directions, the inductor 112 has no voltage across it when the valve 114 is off, and there is a 13,200 volt line to neutral.

A standard design practice is for the voltage rating across the valve to be two times the peak voltage rating, or 13,200×2×sqrt(2)˜37,336 volts. Using thyristors that are each rated at 6,500 volts, six thyristor-thyristor pairs 602 are needed. If a redundancy of two pairs is desired, eight thyristor-thyristor pairs 602 are needed. The level of redundancy can be higher or lower. At higher voltages or different thyristor ratings, the number of thyristor-thyristor pairs 602 is changed as needed.

As in the previous implementation, the monitor 120 is integrated between the valve 114 and a thyristor bank controller 204. The integration can be performed during initial construction or by retrofitting. The monitor 120 contains four detection groups (e.g., detection groups 606a-d) that each monitors a group (e.g., group 608a-d) of two thyristor-thyristor pairs 602. In the example shown in FIG. 2, detection group 606a monitors two thyristor-thyristor pairs 602 in group 608a, detection group 606b monitors two thyristor-thyristor pairs 602 in group 608b, detection group 606c monitors two thyristor-thyristor pairs 602 in group 608c, and detection group 606d monitors two thyristor-thyristor pairs 602 in group 608d. Each of the detection groups 606a-d is connected to two taps 610 and measures the voltage difference between the two taps, for example, in hardware, such as a dropping network (e.g., a resistor divider, a transformer, a set of reactors, or a set of capacitors), or in software, by passing the measured voltages to a processor for further analysis. As shown in the implementation of FIG. 6, the taps 610 include a resistor divider network. More generally, a minimum number of the detection groups 606a-d is needed to detect patterns of failure among the groups 608 of thyristor-thyristor pairs 602. The minimum number of detection groups 606a-d depends on the redundancy of the system and is typically equal to two more than the redundancy of thyristor-thyristor pairs 602 in the valve 114. In the monitor 120 of FIG. 6, four detection groups 606a-d are sufficient to monitor the eight thyristor-thyristor pairs 602.

Referring to FIG. 4B, a table 450 lists data obtained by the measurement process described in the flowchart 300 for groups 608a-d of thyristors in the example valve 114 shown in FIG. 6. Listed at the bottom of table 450 are the voltages measured across the four groups 608a-d of thyristor-thyristor pairs 602 when all thyristors are functioning properly. Voltages are expressed as a percentage of the voltage drop between the point 604 (which is typically at a voltage of 25,000 volts) and the inductor 112. Because of the symmetry in each of the four groups, each detection group 606a-d measures a voltage between two taps 610 on either side of a group of two thyristor-thyristor pairs 602 to be 25%. These symmetries reduce the number of separate measurements required for recording voltages across each of group 608a-d when a number of failed thyristors are distributed among the groups.

Referring to the other rows of table 450, measured voltages across the groups 608a-d are listed, in which one, two, or three shorted thyristors are distributed among the groups. A negative voltage value indicates that the voltage across a group has decreased and the group contains one or two shorted thyristors. For example, the top row of table 450 lists voltages measured when one failed thyristor is distributed among groups 208a-d. A voltage of 14.3% is measured across each of groups 608a, 608c, and 608d, and a voltage of −42.9% is measured across group 608b. As such, the failed switch is localized to group 608b. Because of the noted symmetry in the groups, the voltage across any group that contains one failed switch would be −42.9%, and the voltage across the remaining groups that each has two properly-functioning thyristors would be 14.3%. This is confirmed in the fifth row of table 450, in which group 608a contains the failed switch.

The remaining rows of table 450 list the measured voltages across the groups 608a-d, in which two or three shorted thyristors are distributed among the groups.

While the above examples have described monitoring thyristors within SVCs, the methods and systems described can also be applied to monitor other switches or switching devices, including but not limited to silicon controlled switches, rectifiers, transistors, and bi-directional triode thyristors (also called “triacs”).

The techniques described herein can be implemented in one or more of digital electronic circuitry, computer hardware, firmware, or software. The techniques can be implemented as logic gates or a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by and apparatus of the invention can be implemented as special purpose logic circuitry, e.g., a field programmable gate array (FPGA) or an application-specific integrated circuit (ASIC). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., random access memory (RAM), magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user (e.g., a warning that alerts of failed thyristors), the techniques described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element, for example, by clicking a button on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

It is to be understood that the foregoing description is intended to illustrate and not to limit the scope of the invention, which is defined by the scope of the appended claims. Other embodiments are within the scope of the following claims.

What is claimed is:

1. A sensing circuit configured for use with a switching network including a plurality of switches, the sensing circuit comprising:
a plurality of detecting networks, the plurality of detecting networks being fewer than the plurality of switches, each detecting network providing signals indicative of a failure of at least one of the switches.

2. The circuit of claim 1 wherein the plurality of detecting networks are configured to send a warning signal if the failed switches are greater in number than zero and fewer than or equal to a number of redundant switches in the switching network.

3. The circuit of claim 1 wherein the plurality of detecting networks are configured to send a trip signal to disable the switching network if the failed switches are greater in number than the number of redundant switches.

4. A sensing circuit configured for use with a switching network including a plurality of switches and having a number of redundant switches, the sensing circuit comprising:
a plurality of detecting networks configured to send a warning signal indicative of a number of failed switches greater than zero and fewer than or equal to the number of redundant switches; and
at least one of the detecting networks configured to disable the switching network if a number of failed switches is greater than the number of redundant switches.

5. The sensing circuit of claim 4 wherein the plurality of detecting networks is fewer than the number of switches.

6. A sensing circuit configured for use with a switching network including a plurality of switches and having a number of redundant switches, the sensing circuit comprising:
a plurality of detecting networks, the plurality of detecting networks being fewer than the plurality of switches, the detecting networks configured to send a warning signal indicative of a number of failed switches greater than zero and fewer than or equal to the number of redundant switches; and
at least one of the detecting networks disabling the switching network if a number of failed switches is greater than the number of redundant switches.

7. The sensing circuit of claim 6 wherein each of the plurality of detecting networks monitors, at most, a number of switches equaling of all switches in the switching network divided by the number of detecting networks.

8. The sensing circuit of claim 6 wherein a number of detecting networks equals at least two more than the number of redundant switches.

9. The sensing circuit of claim 6 wherein the switches of the switching network are in series.

10. The sensing circuit of claim 6 wherein the number of redundant switches is two or more.

11. The sensing circuit of claim 6 wherein the plurality of switches comprises one or more high-power semiconductor switch-diode pairs or one or more high-power semiconductor switch-switch pairs.

12. The sensing circuit of claim 6 wherein the plurality of detecting networks detect voltage.

13. The sensing circuit of claim 6 wherein the plurality of detecting networks comprises dropping networks.

14. The sensing circuit of claim 13 wherein the dropping networks comprise one or more of a resistor divider, a transformer, a set of reactors, or a set of capacitors.

15. The sensing circuit of claim 6 wherein the plurality of detecting networks comprises a differential amplifier.

16. The sensing circuit of claim 6 wherein the plurality of detecting networks comprises a processor that compares voltages across one or more of the plurality of switches.

17. A method of monitoring a switching network including a plurality of switches, the method comprising:
obtaining signals from each of a plurality of detecting networks, wherein at least one detecting network monitors two or more switches;
determining a number of failed switches in the switching network based on the received signal; and
performing one or more actions depending on the number of failed switches in the switching network.

18. The method of claim 17, wherein obtaining signals comprises measuring voltages across one or more switches using a dropping network or a differential amplifier.

19. The method of claim 17, wherein determining comprises comparing the received signals to stored signals representative of a known number of failed switches.

20. The method of claim 17, wherein performing one or more action depending on the number of failed switches in the switching network comprises:
sending a warning signal indicative of the number of failed switches if the number of failed switches is greater than zero and fewer than or equal to a number of redundant switches in the switching network; and
disabling the switching network if the number of failed switches is greater than the number of redundant switches in the switching network.
